(19) United States
(12) Patent Application Publication
(10) Pub. No.: US 2026/0171825 A1
(43) Pub. Date: Jun. 18, 2026

(54) CRADLES FOR A MOBILE DEVICE INCLUDING A CAVITY FOR A WIRELESS DEVICE AND METHODS OF MAKING AND USING

(71) Applicant: National Products, Inc., Seattle, WA (US)

(72) Inventor: Jeffrey D. Carnevali, Seattle, WA (US)

(21) Appl. No.: 18/979,376

(22) Filed: Dec. 12, 2024

(51) Int. Cl. H02J 7/00; F16B 2/12; F16M 13/02; H04M 1/04

(52) U.S. Cl. CPC H02J 7/731; F16B 2/12; F16M 13/02; H04M 1/04; F16M 2200/06

(57) ABSTRACT

A cradle for a mobile device includes a cradle base defining a cavity for receiving a wireless device for interacting with the mobile device; a first device receiver to receive and retain a first portion of the mobile device; a first slide arm coupled to the first device receiver and extending into the cradle base, wherein the first slide arm is slidably adjustable with respect to the cradle base and biased toward the cradle base; a second device receiver disposed opposite the first device receiver to receive and retain a second portion of the mobile device; a second slide arm coupled to the second device receiver and extending into the cradle base, wherein the second slide arm is slidably adjustable with respect to the cradle base; and at least one first fastener to fix the second slide arm to the cradle base at a user-selected position.

### FIELD

The present invention is directed to cradles for a mobile device. The present invention is also directed to a cradle for a mobile device including a cavity for a wireless charging device or other wireless device and methods of making and using.

### BACKGROUND

Mobile devices, such as smartphones, cellular or mobile phones, tablets, personal data assistants, and other portable devices, are now ubiquitous. Cradles can be used to protect the mobile device and to mount the mobile device onto a surface or object.

### BRIEF SUMMARY

One embodiment is a cradle for a mobile device. The cradle includes a cradle base defining a cavity sized and configured for receiving a wireless device configured for wirelessly interacting with the mobile device received in the cradle; a first device receiver configured to receive and retain a first portion of the mobile device received in the cradle; a first slide arm coupled to the first device receiver and extending into the cradle base, wherein the first slide arm is slidably adjustable with respect to the cradle base and biased toward the cradle base; a second device receiver disposed opposite the first device receiver and configured to receive and retain a second portion of the mobile device received in the cradle; a second slide arm coupled to the second device receiver and extending into the cradle base, wherein the second slide arm is slidably adjustable with respect to the cradle base; and at least one first fastener to fix the second slide arm to the cradle base at a user-selected position and hinder or prevent further sliding of the second slide arm relative to the cradle base unless the at least one first fastener is released.

In at least some embodiments, the cradle further includes a third device receiver configured to receive and retain a third portion of the mobile device received in the cradle; a third slide arm coupled to the third device receiver and extending into the cradle base, wherein the third slide arm is slidably adjustable with respect to the cradle base; a fourth device receiver disposed opposite the third device receiver and configured to receive and retain a fourth portion of the mobile device received in the cradle; and a fourth slide arm coupled to the fourth device receiver and extending into the cradle base, wherein the fourth slide arm is slidably adjustable with respect to the cradle base.

In at least some embodiments, the cradle further includes at least one second fastener to fix at least one of the third slide arm or the fourth slide arm to the cradle base at a user-selected position and hinder or prevent further sliding of the one of the third slide arm or the fourth slide arm relative to the cradle base unless the at least one second fastener is released. In at least some embodiments, the cradle includes a plurality of the third device receivers and a plurality of the fourth device receivers. In at least some embodiments, all of the third device receivers are coupled to a same third side arm. In at least some embodiments, the cradle includes a plurality of the third side arms and at least two of the third device receivers are coupled to different third side arms.

In at least some embodiments, the second slide arm is biased toward the cradle base. In at least some embodiments, the cradle base further defines a cord channel extending from the cavity, wherein the cord channel is configured for receiving a cord extending from the wireless device. In at least some embodiments, at least one of the first device receiver or the second device receiver includes a finger. In at least some embodiments, the at least one of the first device receiver or the second device receiver includes a plurality of the fingers. In at least some embodiments, at least one of the first device receiver or the second device receiver includes a cup.

In at least some embodiments, the cradle further includes a spring disposed around a portion of the first side arm to bias the first side arm toward the cradle base. In at least some embodiments, the cradle base includes a first slide arm housing configured to receive a portion of the first slide arm. In at least some embodiments, the cradle base includes mounting holes configured for coupling of a mount or mounting arm to the cradle.

Another embodiment is a system that includes any of the cradles described above and the wireless device. In at least some embodiments, the wireless device is a wireless charging device. In at least some embodiments, the system further includes the mobile device. In at least some embodiments, the system further includes a mount or mounting arm coupled or coupleable to the cradle.

Yet another embodiment is a system that includes any of the cradles described above and the mobile device.

A further embodiment is a system that includes any of the cradles described above and a mount or mounting arm coupled or coupleable to the cradle.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1A is a schematic perspective front view of one embodiment of a cradle for a mobile device with a wireless device disposed thereon, according to the invention;

FIG. 1B is a schematic perspective front view of the cradle of FIG. 1A with the wireless device removed, according to the invention;

FIG. 1C is a schematic perspective back view of the cradle of FIG. 1A, according to the invention;

FIG. 2A is a schematic perspective front view of another embodiment of a cradle for a mobile device with a wireless device disposed thereon, according to the invention;

FIG. 2B is a schematic perspective front view of the cradle of FIG. 2A with the wireless device removed, according to the invention;

FIG. 2C is a schematic perspective front view of the cradle of FIG. 2A with the mobile device received in the cradle, according to the invention;

FIG. 2D is a schematic cross-sectional view of the cradle of FIG. 2A along the line 2D-2D in FIG. 2C;

FIG. 2E is another schematic cross-sectional view of the cradle of FIG. 2A along the line 2E-2E in FIG. 2C;

FIG. 2F is a schematic perspective back view of the cradle of FIG. 2A, according to the invention;

FIG. 2G is a schematic perspective front view of the cradle of FIG. 2A with a mounting arm attached to the cradle, according to the invention; and

FIG. 2H is a schematic perspective back view of the cradle of FIG. 2A with a mount and a mounting arm attached to the cradle, according to the invention.

### DETAILED DESCRIPTION

The present invention is directed to cradles for a mobile device. The present invention is also directed to a cradle for a mobile device including a cavity for a wireless charging device or other wireless device and methods of making and using.

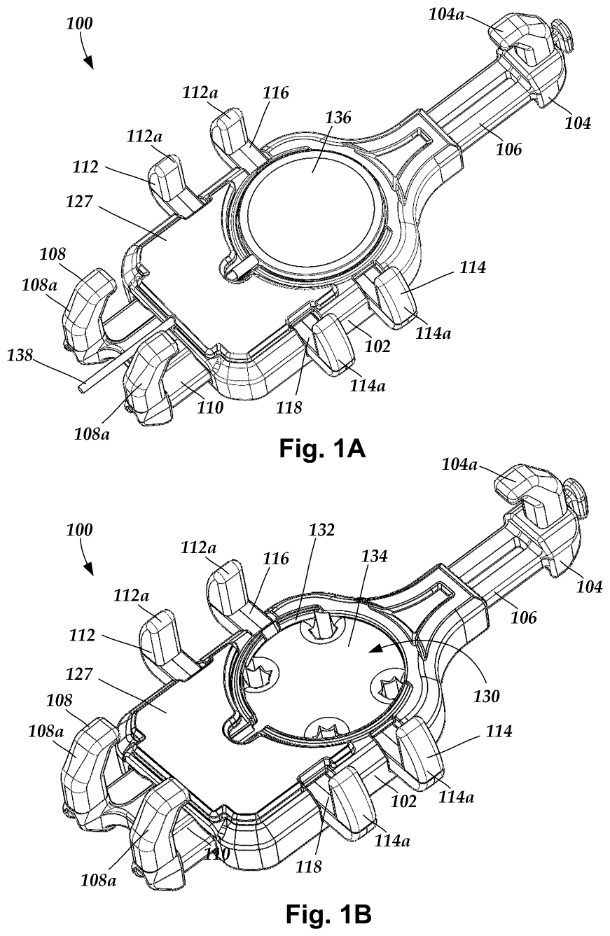

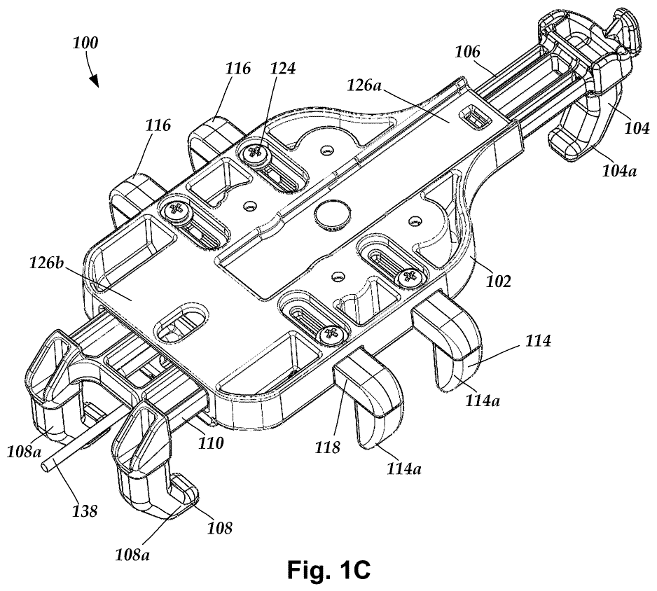

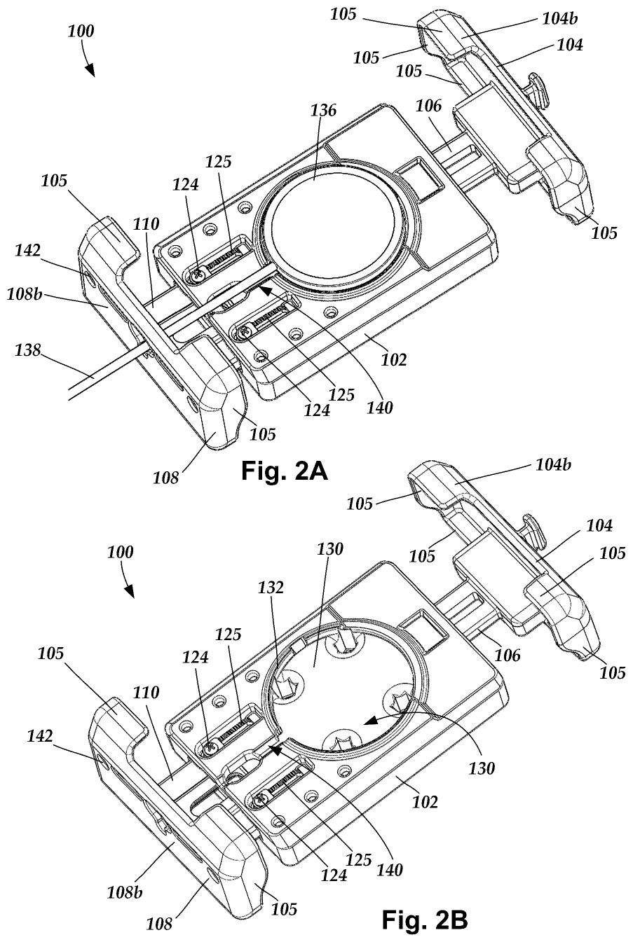

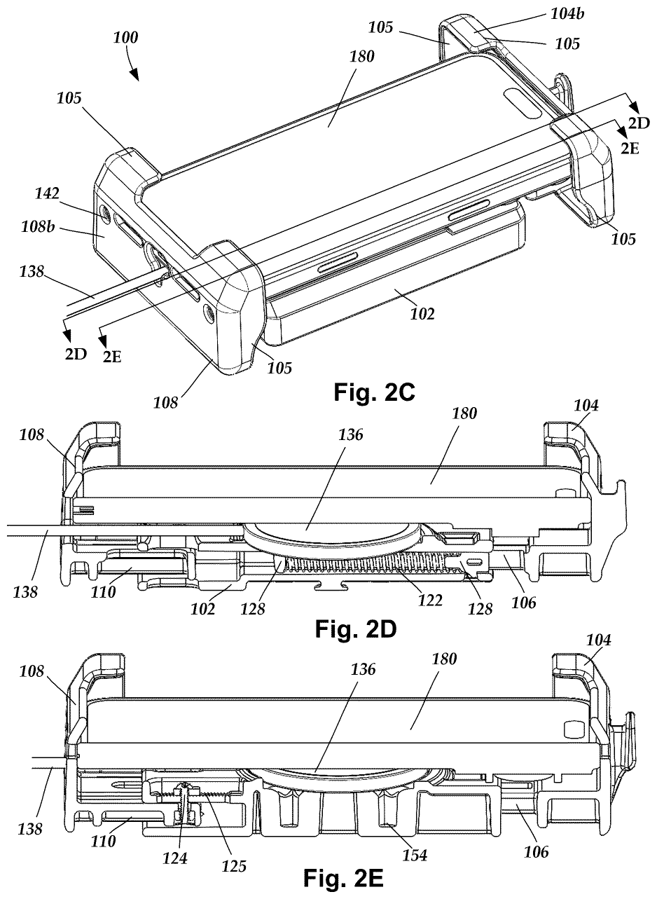

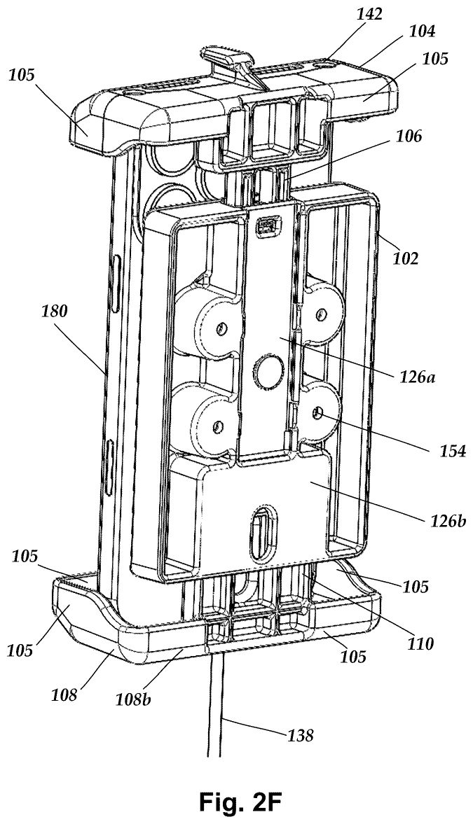

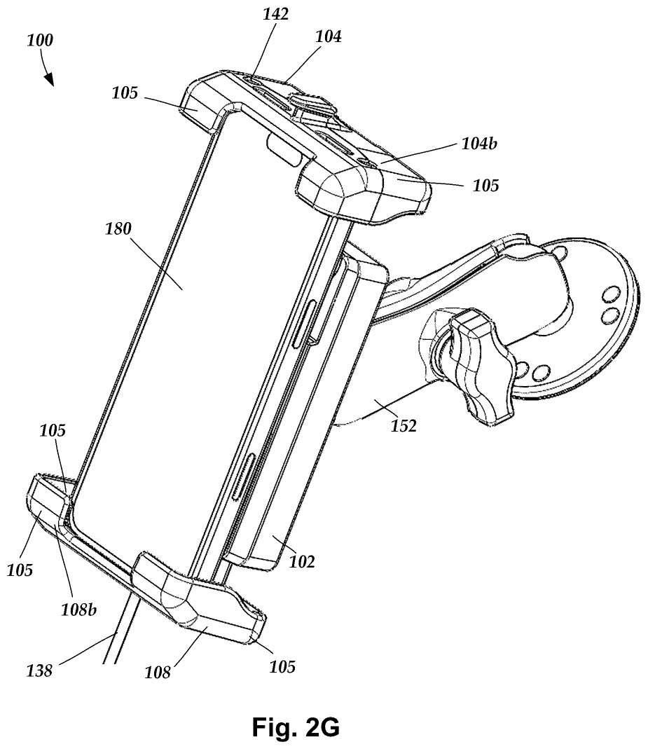

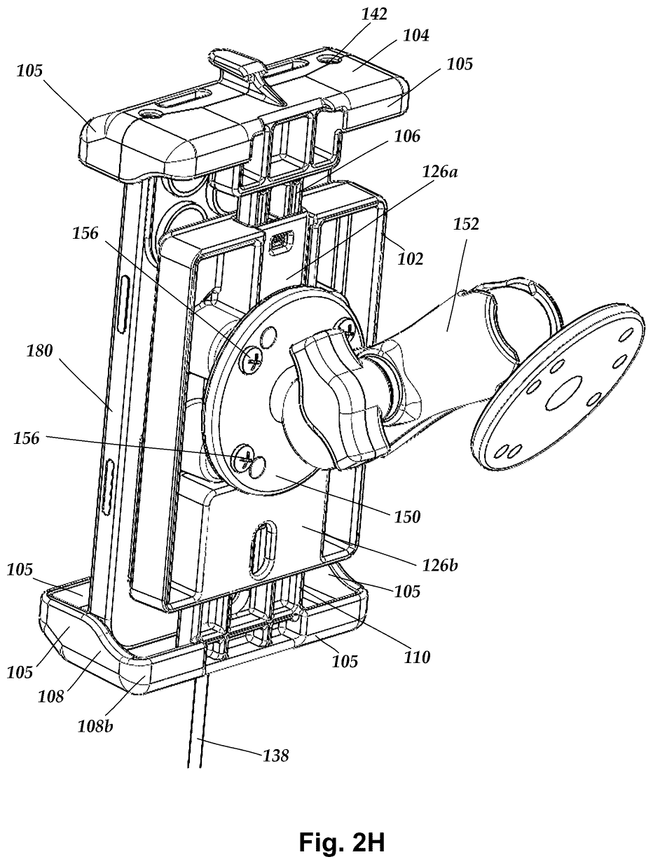

FIGS. 1A to 1C illustrate one embodiment of a cradle 100 and FIGS. 2A to 2H illustrate another embodiment of the cradle 100. Each cradle 100 receives a mobile device 180, such as a cellular or mobile phone, a smartphone, a tablet, a personal data assistant, or any other suitable mobile device, as illustrated in FIG. 2C. Each cradle 100 includes a cradle base 102 and at least one first device receiver 104, such as at least one first finger 104a (FIG. 1A) or first cup 104b (FIG. 2A), for receiving a first portion of the mobile device, and at least one first slide arm 106 coupled to the first device receiver and extending into the cradle base. In at least some embodiments, the first device receiver 104 is arranged to receive a top portion of the mobile device. In other embodiments, the at least one first device receiver 104 is arranged to receive a bottom portion or a side portion of the mobile device. In at least some embodiments, at least one first slide arm 106 is biased toward the cradle base 102.

In at least some embodiments, a finger, such as first finger 104a, extends over only a portion (e.g., no more than 5, 10, 15, 20, 25, 30, 35, 50, 67, or 75%) of the length of the side received by the device receiver, such as first device receiver 104, as illustrated in FIG. 1A. In at least some embodiments, a cup, such as first cup 104b, extends over an entire length of the side received by the device receiver, such as first device receiver 104, as illustrated in FIG. 2A. In at least some embodiments, the cup, such as first cup 104b, includes sidewalls 105 that extend over portions of four or more surfaces of the mobile device.

The cradle 100 also includes at least one second device receiver 108, such as at least one second finger 108a (FIG. 1A, which illustrates two second fingers 108a) or a second bottom cup 108b (FIG. 2A), for receiving a second portion of the mobile device. The at least one second device receiver 108 is disposed opposite the at least one first device receiver 104. The cradle further includes at least one second slide arm 110 coupled to the second device receiver(s) 108 and extending into the cradle base 102. In at least some embodiments, the at least one second device receiver 108 is arranged to receive a bottom portion of the mobile device. In at least some embodiments, at least one second slide arm 106 is biased toward the cradle base 102.

The cradle 100 optionally includes at least one third device receiver 112, such as the two third fingers 112a illustrated in FIG. 1A, for receiving a third portion of the mobile device. The cradle optionally includes at least one third slide arm 116 coupled to the at least one third device receiver 112 and extending into the cradle base 102. In at least some embodiments, the third device receiver 112 is arranged to receive a first side portion of the mobile device. In at least some embodiments, at least one third slide arm 116 is biased toward the cradle base 102.

The cradle 100 optionally includes at least one fourth device receiver 114 such as the two fourth fingers 114a illustrated in FIG. 1A, for receiving a fourth portion of the mobile device. The at least one fourth device receiver is disposed opposite the at least one third device receiver 112. The cradle optionally includes at least one fourth slide arm 118 coupled to the at least one fourth device receiver 114 and extending into the cradle base 102. In at least some embodiments, the fourth device receiver 114 is arranged to receive a second side portion of the mobile device. In at least some embodiments, at least one fourth slide arm 118 is biased toward the cradle base 102.

As an example, one arrangement of the embodiment of the cradle 100 illustrated in FIGS. 1A to 1C includes a first device receiver 104 (presented as a single first finger 104a) coupled to a first slide arm 106 that is biased toward the cradle base 102, a second device receiver 108 (presented as a pair of second fingers 108a) coupled to a second slide arm 110, two third device receivers 112 (presented as two third fingers 112a) each coupled to a different one of two third slide arms 116, and two fourth device receivers 114 (presented as two fourth fingers 114a) each coupled to a different one of two fourth slide arms 118. Optionally, the second slide arm 110 is biased toward the cradle base 102. In at least some arrangements, the first device receiver 104 receives a top of the mobile device, the second device receiver 108 receives the bottom of the mobile device, and the third and fourth device receivers 112, 114 receive opposing sides of the mobile device.

As another example, one arrangement of the embodiment of the cradle 100 illustrated in FIGS. 2A to 2H includes a first device receiver 104 (presented as a first cup 104b) coupled to a first slide arm 106, which is biased toward the cradle base 102, and a second device receiver 108 (presented as a second cup 108b) coupled to a second slide arm 110. In at least some arrangements, the first device receiver 104 receives a top of the mobile device and the second device receiver 108 receives the bottom of the mobile device.

The first, second, third, and fourth device receivers 104, 108, 112, 114 are illustrated as fingers or cups, but it will be understood that any other suitable arrangement for receiving and retaining a top portion, bottom portion, or side portion of the mobile device can be used including, but not limited to, clips, retention arms, or the like or any combination thereof.

In at least some embodiments, any of the first, second, third, and fourth device receivers 104, 108, 112, 114 can include one or more openings 142 (FIG. 2A) for access to a speaker, microphone, button, or other element on the mobile device 180.

The first, second, third, or fourth slide arms 106, 110, 116, 118 are slidable relative to the cradle base 102 to permit use of the cradle 100 with mobile devices of different lengths or widths. In at least some embodiments, at least one of the first, second, third, or fourth slide arms 106, 110, 116, 118 is biased toward the cradle base 102 to hold the mobile device in the cradle 100. In at least some embodiments, a spring 122 (FIG. 2D) or other biasing element is coupled to the biased slide arm (for example, the first slide arm 106 in FIG. 2A) so that the corresponding device receiver (for example, the first device receiver 104 in FIG. 2A) can be pulled away from the cradle base 102 for loading the mobile device onto the cradle 100 or removing the mobile device from the cradle. When released, the corresponding device receiver (for example, the first device receiver 104 in FIG. 2A) moves toward the cradle base 102 to grip the mobile device, when loaded onto the cradle 100. As another example (e.g., some arrangements of the cradle of FIGS. 1A to 1C), two opposing slide arms (for example, the first slide arm 104 and the second slide arm 106 of FIGS. 1A to 1C) are biased toward the cradle base with each side arm associated with an accompanying spring 122 (FIG. 2B) or other biasing element.

One or more of the first, second, third, or fourth slide arms 106, 110, 116, 118 are arranged to be fixed, in position, to the cradle base 102 using at least one fastener 124, as illustrated in FIGS. 1C and 2A. Examples of fasteners include, but are not limited to, screws, bolts, latches, pins, detents, or the like or any combination thereof. In FIG. 2A, the second slide arm 110 is fixed to the cradle base 102 by two fasteners 124. In FIG. 1C, the two third slide arms 116 and two fourth side arms 118 are individually fixed to the cradle base 102 by fasteners 124. Optionally, in FIG. 1A, the second slide arm 110 is fixed to the cradle base 102 using a fastener that is obscured by a removable plate 127. In at least some embodiments, the surface of a side arm, such as second side arm 110 of FIG. 2C, includes teeth 125 for engagement by the fastener 124.

In operation, a user can release one or more of the fasteners 124 to allow adjustment of a corresponding slide arm to a desired position. For example, in the cradle 100 of FIG. 1B, one or more of the fasteners 124 can be released (e.g., loosened, unlatched, or opened) to allow a user to adjust the separation between the third device receivers 112 and fourth device receivers 114 for receiving a mobile device of a corresponding width or length. The fastener(s) are engaged (e.g., tightened, latched, or closed) to maintain that separation. As another example, in the cradle 100 of FIG. 2A, the fasteners 124 can be released to allow the user to adjust the position of the second device receiver 108 relative to the cradle base 102 and then engaged to maintain the selected position. The first device receiver 104 and slide arm 106 are slidably adjustable, and biased toward the cradle base 102, to load or remove the mobile device. The adjustability provided by the slide arms, fastener(s), and spring(s) (or other biasing elements) allows the cradle 100 to be used with mobile devices having differing sizes, lengths, or widths.

The cradle base 102 includes one or more slide arm housings for receiving portions of one or more of the slide arms. For example, in at least some embodiments, the first slide arm 106 extends away from the first device receiver 104 and into a first slide arm housing 126a on a back side of the cradle base 102 and the second slide arm 110 extends away from the second device receiver 108 and into a second slide arm housing 126b, as illustrated in FIGS. 1C and 2F. In at least some embodiments, the third and fourth slide arms 116, 118 each extend away from the respective third and fourth device receivers 112, 114 and into the first or second slide arm housing 126a, 126b or another slide arm housing. In FIG. 1C, the third and fourth slide arms 116, 118 extend into either the second slide arm housing 126b or one of two additional slide arm housings. For a slide arm associated with a biasing element, such as spring 122, the biasing element may also be disposed within the corresponding slide arm housing. For example, in FIG. 2D, the spring 122 disposed in the first slide arm housing 126a around a portion of the first slide arm 106.

In at least some embodiments, a slide arm housing (such as first slide arm housing 126a of FIG. 2D) or slide arm (such as first slide arm 106 of FIG. 2D) includes at least one stop 128 to prevent or resist removal of the slide arm (for example, the first side arm 106) entirely from the slide arm housing or to prevent or resist pushing the slide arm further into the slide arm housing. In at least some embodiments, as a device receiver (such as first device receiver 104 in FIG. 2D) is pulled away from the cradle base 102, the spring 122 is compressed against a stop 128. When the device receiver is released, the spring 122 can expand, drawing the slide arm (e.g., slide arm 106 in FIG. 2D) further into the cradle base 102.

The cradle base 102 defines a cavity 130 (FIGS. 1B and 2B) with cavity sidewalls 132 and a cavity floor 134 for receiving a wireless device 136 (FIGS. 1A and 2A), such as a wireless charging device, wireless, charging puck, or any other suitable other wireless device. The wireless device 136 is capable of interacting with the mobile device 180 wirelessly to charge or communicate (or both charge and communicate) with the mobile device received in the cradle 100. In at least some embodiments, the wireless device 136 is connected to a power or data source by a cord 138. In at least some embodiments, the cavity sidewalls 132 and, optionally, the cradle base 102 beyond the cavity define a cord channel 140 for the cord 138 of the wireless device 136 out of the cavity 130 and out of the cradle 100, as illustrated in FIGS. 1A and 2A. In at least some embodiments, the cradle 100 can include a removable plate 127 (FIG. 1A) that can cover at least a portion of the cord channel 140, at least a portion of the cavity 130, or any combination thereof.

In at least some embodiments, an optional mount 150 (FIG. 2H) with or without a mounting arm 152 (FIGS. 2G and 2H) is coupled or coupleable to the cradle 100 using one or more mounting holes 154 (FIG. 2F) which each receive a fastener 156 (FIG. 2H), such as a screws, bolts, latches, pins, detents, or the like or any combination thereof, to couple the mount to the cradle 100. Non-limiting examples of mounts and mounting arms can be found at U.S. Pat. Nos. 5,845,885; 6,561,476; 7,997,554; 8,454,178; 8,505,861; 9,831,904; RE42,060; RE42,581; and RE43,806, all of which are incorporated herein by reference.

The above specification provides a description of the invention and the manufacture and use of the invention. Since many embodiments of the invention can be made without departing from the spirit and scope of the invention, the invention also resides in the claims hereinafter appended.

What is claimed as new and desired to be protected is:

1. A cradle for a mobile device, the cradle comprising:
a cradle base defining a cavity sized and configured for receiving a wireless device configured for wirelessly interacting with the mobile device received in the cradle;
a first device receiver configured to receive and retain a first portion of the mobile device received in the cradle;
a first slide arm coupled to the first device receiver and extending into the cradle base, wherein the first slide arm is slidably adjustable with respect to the cradle base and biased toward the cradle base;
a second device receiver disposed opposite the first device receiver and configured to receive and retain a second portion of the mobile device received in the cradle;
a second slide arm coupled to the second device receiver and extending into the cradle base, wherein the second slide arm is slidably adjustable with respect to the cradle base; and
at least one first fastener to fix the second slide arm to the cradle base at a user-selected position and hinder or prevent further sliding of the second slide arm relative to the cradle base unless the at least one first fastener is released.

2. The cradle of claim 1, further comprising
a third device receiver configured to receive and retain a third portion of the mobile device received in the cradle;
a third slide arm coupled to the third device receiver and extending into the cradle base, wherein the third slide arm is slidably adjustable with respect to the cradle base;
a fourth device receiver disposed opposite the third device receiver and configured to receive and retain a fourth portion of the mobile device received in the cradle; and
a fourth slide arm coupled to the fourth device receiver and extending into the cradle base, wherein the fourth slide arm is slidably adjustable with respect to the cradle base.

3. The cradle of claim 2, further comprising at least one second fastener to fix at least one of the third slide arm or the fourth slide arm to the cradle base at a user-selected position and hinder or prevent further sliding of the one of the third slide arm or the fourth slide arm relative to the cradle base unless the at least one second fastener is released.

4. The cradle of claim 2, wherein the cradle comprises a plurality of the third device receivers and a plurality of the fourth device receivers.

5. The cradle of claim 4, wherein all of the third device receivers are coupled to a same third side arm.

6. The cradle of claim 4, wherein the cradle comprises a plurality of the third side arms and at least two of the third device receivers are coupled to different third side arms.

7. The cradle of claim 1, wherein the second slide arm is biased toward the cradle base.

8. The cradle of claim 1, wherein the cradle base further defines a cord channel extending from the cavity, wherein the cord channel is configured for receiving a cord extending from the wireless device.

9. The cradle of claim 1, wherein at least one of the first device receiver or the second device receiver comprises a finger.

10. The cradle of claim 9, wherein the at least one of the first device receiver or the second device receiver comprises a plurality of the fingers.

11. The cradle of claim 1, wherein at least one of the first device receiver or the second device receiver comprises a cup.

12. The cradle of claim 1, further comprising a spring disposed around a portion of the first side arm to bias the first side arm toward the cradle base.

13. The cradle of claim 1, wherein the cradle base comprises a first slide arm housing configured to receive a portion of the first slide arm.

14. The cradle of claim 1, wherein the cradle base comprises mounting holes configured for coupling of a mount or mounting arm to the cradle.

15. A system, comprising:
the cradle of claim 1; and
the wireless device.

16. The system of claim 15, wherein the wireless device is a wireless charging device.

17. The system of claim 15, further comprising the mobile device.

18. The system of claim 15, further comprising a mount or mounting arm coupled or coupleable to the cradle.

19. A system, comprising:
the cradle of claim 1; and
the mobile device.

20. A system, comprising:
the cradle of claim 1; and
a mount or mounting arm coupled or coupleable to the cradle.
